(19) United States
(12) Patent Application Publication
(10) Pub. No.: US 2010/0201669 A1
(43) Pub. Date: Aug. 12, 2010

(54) DISPLAY APPARATUS AND METHOD THEREOF

(75) Inventors: Taek-Young KIM, Anyang-si (KR); Bum-Jin KIM, Cheonan-si (KR); Seung-Jae KANG, Asan-si (KR); Sung-Wook KANG, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/536,709

(22) Filed: Aug. 6, 2009

(30) Foreign Application Priority Data
Feb. 9, 2009 (KR) 2009-0010078

(51) Int. Cl. G09G 5/00; G09G 3/36

(52) U.S. Cl. 345/211; 345/87

(57) ABSTRACT

A display apparatus includes a voltage generator, a display panel and a panel driving part. The voltage generator includes an operation amplifier including a first input terminal electrically connected to a reference voltage receiving terminal, a second input terminal receiving a feedback common voltage and an output terminal outputting a common voltage generated by comparing a reference voltage received at the reference voltage receiving terminal and the feedback common voltage and a first resistor electrically connected between the second input terminal and the output terminal. The display panel includes a dummy line electrically connected in series between a first connection line and a second connection line, and the dummy line provides the feedback common voltage to the second input terminal through the first connection line. The panel driving part drives the display panel.

This application claims priority to Korean Patent Application No. 2009-10078, filed on Feb. 9, 2009, and all the benefits accruing therefrom under 35 U.S.C. §119, the contents of which are herein incorporated by reference in their entirety.

### BACKGROUND OF THE INVENTION

1. Field of the Invention

Exemplary embodiments of the present invention relate to a display apparatus. More particularly, exemplary embodiments of the present invention relate to a display apparatus capable of improving display quality.

2. Description of the Related Art

A liquid crystal display (“LCD”) apparatus includes an LCD panel displaying images using the light transmittance of liquid crystal, a panel driving part driving the LCD panel and a backlight assembly disposed under the LCD panel and providing light to the display panel.

The LCD panel includes a display substrate on which a plurality of switching elements is disposed, an opposite substrate facing the display substrate and a liquid crystal layer interposed between the display substrate and the opposite substrate.

A plurality of gate lines and a plurality of data lines are disposed on the display substrate. The data lines respectively cross the gate lines. A plurality of pixel areas is respectively defined on the display substrate, such as being defined by the gate lines and the data lines. A plurality of unit pixels is respectively disposed on the pixel areas.

Each of the unit pixels includes a switching element electrically connected to a gate line and a data line, a liquid crystal capacitor and a storage capacitor electrically connected to the switching element. The switching element includes a gate electrode electrically connected to the gate line, a drain electrode electrically connected to the data line and a source electrode spaced apart from the drain electrode. The drain electrode is electrically connected to a pixel electrode which is a first electrode of the liquid crystal capacitor. The storage capacitor is electrically connected to a storage line applying a first common voltage.

The opposite substrate includes a common electrode which acts as a second electrode of the liquid crystal capacitor and receives a second common voltage.

In the LCD which has the above structure, a parasitic capacitance occurs between the gate line and the data line, or between the data line and the storage line. Thus, the first and second common voltages are undesirably distorted. When a width of the data line or a width of the storage line is undesirably increased due to process variations, the parasitic capacitance increases and the distortion of the first and second common voltages increases as well. The distortion of the first and second common voltages causes distortion of a data voltage which is charged in the liquid crystal capacitor, and the distortion of the data voltage generates crosstalk. The crosstalk decreases the display quality of the LCD apparatus.

### BRIEF SUMMARY OF THE INVENTION

Exemplary embodiments of the present invention provide a display apparatus improving display quality.

According to an exemplary embodiment of the present invention, there is provided a display apparatus including a voltage generator, a display panel and a panel driving part. The voltage generator includes an operation amplifier including a first input terminal electrically connected to a reference voltage receiving terminal, a second input terminal receiving a feedback common voltage and an output terminal outputting a common voltage generated by comparing a reference voltage received at the reference voltage receiving terminal and the feedback common voltage and a first resistor electrically connected between the second input terminal and the output terminal. The display panel includes a dummy line electrically connected in series between a first connection line and a second connection line, the dummy line provides the feedback common voltage to the second input terminal through the first connection line. The panel driving part drives the display panel.

In an exemplary embodiment, the display panel may include a display substrate including a display area in which gate and data lines are disposed and a peripheral area surrounding the display area, the gate and data lines respectively crosses each other, an opposite substrate including a common electrode and a liquid crystal layer interposed between the display substrate and the opposite substrate.

In an exemplary embodiment, the dummy line may be disposed in the peripheral area, and may include substantially the same material as the data line.

In an exemplary embodiment, the voltage generator may further include a second resistor electrically connected to the second input terminal of the operation amplifier and electrically connected to the dummy line in series.

In an exemplary embodiment, the display substrate may further include a dummy data line electrically connected to a dummy pixel. The dummy line may be the dummy data line.

In an exemplary embodiment, the panel driving part may include a data driving part outputting a data signal to the data line and a gate driving part outputting a gate signal to the gate line.

In an exemplary embodiment, the voltage generator may further include a third resistor electrically connected to a first output terminal of the operation amplifier and a fourth resistor electrically connected to a second output terminal of the operation amplifier.

In an exemplary embodiment, the display substrate may further include a plurality of short points disposed in the peripheral area and applying a second common voltage outputted from the second output terminal to the common electrode and a third connection line electrically connecting the second output terminal to the short points.

In an exemplary embodiment, the display substrate may further include a storage line disposed in the display area and extended substantially in parallel with the gate line.

In an exemplary embodiment, the storage line may include a first storage line extended substantially in parallel with the gate line and a second storage line extended from the first storage line along the data line to overlap with the data line.

In an exemplary embodiment, the display substrate may further include a signal input pad disposed in the peripheral area, electrically connected to a first terminal of the storage line and applying a first common voltage outputted from the first output terminal to the storage line and a signal output pad disposed in the peripheral area, electrically connected to a second terminal of the storage line and applying the feedback common voltage fed back from the storage line to the dummy line through the second connection line.

In an exemplary embodiment, the display substrate may further include a fourth connection line electrically connecting the first output terminal of the operation amplifier to the signal input pad.

According to an exemplary embodiment of the present invention, there is provided a method of forming a display apparatus, the method including providing a voltage generator, providing a display panel, and providing a panel driving part to drive the display panel. The voltage generator includes an operation amplifier including a first input terminal electrically connected to a reference voltage receiving terminal, a second input terminal receiving a feedback common voltage, and an output terminal outputting a common voltage generated by comparing a reference voltage received at the reference voltage receiving terminal, and the feedback common voltage, and a first resistor electrically connected between the second input terminal and the output terminal. The display panel includes a dummy line formed electrically connected in series between a first connection line and a second connection line, the dummy line providing the feedback common voltage to the second input terminal through the first connection line, and a display substrate including a display area in which gate and data lines are formed, and a peripheral area surrounding the display area, the gate and data lines respectively crossing each other. The dummy line includes substantially the same material as the data lines, and the dummy line and the data lines are formed in substantially the same manufacturing process such that when a width of the data lines is changed due to process variations, a width of the dummy line is also changed.

According to the display apparatus of the present invention, a common voltage applied to a display panel is controlled automatically according to a line resistor of a dummy line disposed on the display panel so that distortion of the common voltage may be decreased. Therefore, the display quality of the display apparatus may be improved.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating a display apparatus according to an exemplary embodiment of the present invention;

FIG. 2 is a plan view illustrating a display panel of FIG. 1;

FIG. 3 is a cross-sectional view taken along line I-I′ of FIG. 2;

FIG. 4 is a circuit diagram illustrating the display apparatus of FIG. 1; and

FIG. 5 is a circuit diagram illustrating a display apparatus according to another exemplary embodiment of the present invention.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set fourth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the apparatus in use or operation in addition to the orientation depicted in the figures. For example, if the apparatus in the figures is turned over, elements described as “lower” other elements or features would then be oriented “upper” the other elements or features. Thus, the exemplary term “lower” can encompass both an orientation of above and below. The apparatus may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of an apparatus and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

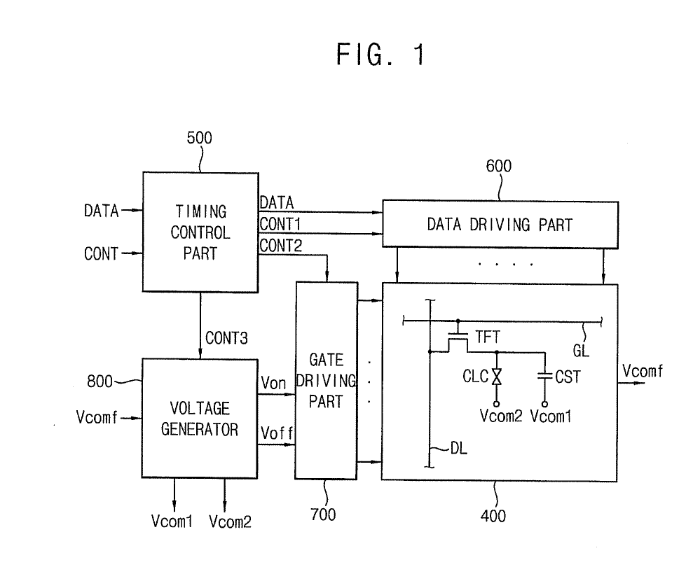

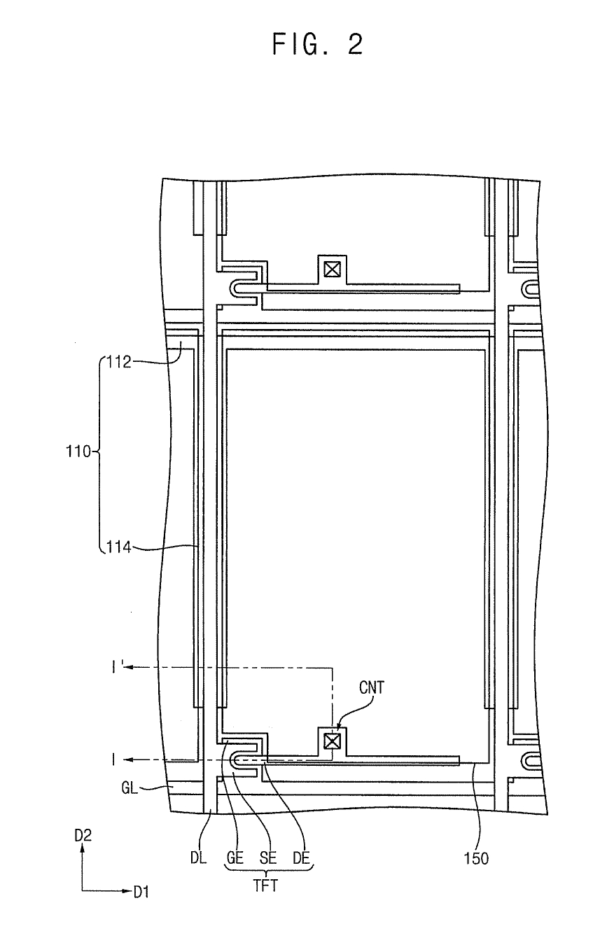

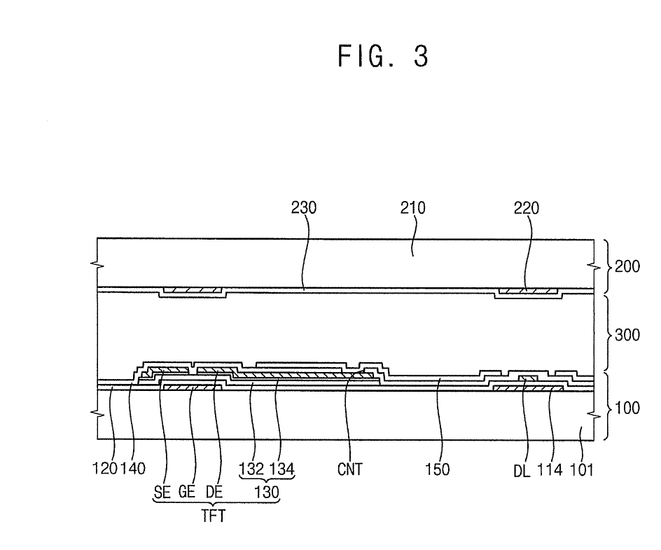

FIG. 1 is a block diagram illustrating a display apparatus according to an exemplary embodiment of the present invention. FIG. 2 is a plan view of the display panel of FIG. 1. FIG. 3 is a cross-sectional view taken along line I-I′ of FIG. 2.

Referring to FIGS. 1, 2 and 3, the display apparatus according to the illustrated exemplary embodiment may include a display panel 400, a timing control part 500, a data driving part 600, a gate driving part 700 and a voltage generator 800.

The display panel 400 may include a display substrate 100, an opposite substrate 200 facing the display substrate and a liquid crystal layer 300 interposed between the display substrate and the opposite substrate.

The display substrate 100 may include a first base substrate 101, a plurality of gate lines GL, a storage line 110, a first insulation layer 120, a plurality of data lines DL, a plurality of switching elements TFT, a second insulation layer 140 and a plurality of pixel electrodes 150.

The gate line GL is disposed on the first base substrate 101, such as directly on an upper surface of the first base substrate 101. The gate line GL is longitudinally extended in a first direction D1. The plurality of the gate lines GL may be disposed substantially in parallel with each other and arranged in a second direction D2, which is inclined with respect to the first direction D1, such as being substantially perpendicular to the first direction D1, as illustrated in the plan view of FIG. 2.

The storage line 110 may include a first storage line 112 and a second storage line 114.

The first storage line 112 is longitudinally extended in the first direction D1. The first storage line 112 partially overlaps with the pixel electrode 150, as illustrated in the plan view of FIG. 2. The first storage line 112 includes a relatively narrow width taken in a direction substantially perpendicular to the longitudinal extension direction (e.g., taken in the second direction D2) to increase an aperture ratio.

The second storage line 114 is extended from the first storage line 112 in the second direction D2. The first and second storage lines 112 and 114 collectively form a unitary indivisible and continuous storage line 110. The second storage line 114 partially overlaps with the data line DL, as shown in FIGS. 2 and 3. The second storage line 114 includes a width taken substantially perpendicular to the longitudinal extension direction, which is larger than a width of the data line DL, to reduce or effectively prevent light leakage from longitudinal sides (e.g., edges) of the data line DL. For example, a portion of the width of the second storage line 114 overlaps an entire of the width of the data line DL, each width taken in the first direction D1. In an exemplary embodiment, the storage line 110 includes an opaque metal to reduce or effectively prevent the light leakage.

Since the storage line 110 is disposed to partially overlap with the data line DL, the light leakage, such as from longitudinal sides (e.g., edges) of the data line DL, may be reduced or effectively prevented, and the aperture ratio may be increased.

The first insulation layer 120 covers the resultant surface of the first base substrate 101 on which a gate electrode GE of the switching element TFT and the second storage line 114 are formed. In an exemplary embodiment, the first insulation layer 120 may include silicon nitride (“SiNx”) or silicon oxide (“SiOx”).

The data line DL is longitudinally extended in the second direction D2. The plurality of the data lines DL may be disposed substantially in parallel with each other and arranged in the first direction D1. In one exemplary embodiment, a unit pixel area may correspond to an area defined by the gate line GL and the data line DL. A plurality of unit pixels is disposed in the unit pixel area. As used herein, “corresponding” may refer to an element being related in position, dimension and/or shape to another element.

Each of the unit pixels may include a switching element TFT, a liquid crystal capacitor CLC and a storage capacitor CST which are electrically connected to the switching element TFT. A first terminal of the liquid crystal capacitor CLC is electrically connected to the pixel electrode 150 which is electrically and physically connected to a drain electrode DE of the switching element TFT. A second terminal of the liquid crystal capacitor CLC is electrically connected to a common electrode 230 receiving a second common voltage Vcom2 (shown in FIG. 1). A first terminal of the storage capacitor CST is electrically connected to the pixel electrode 150. A second terminal of the storage capacitor CST is electrically connected to the storage line 110 receiving a first common voltage Vcom1 (shown in FIG. 1).

Referring to FIGS. 2 and 3, the switching element TFT includes the gate electrode GE, a source electrode SE, a semiconductor pattern 130 and the drain electrode DE. The gate electrode GE is electrically connected to and extended continuously from the gate line GL. The source electrode SE is electrically connected to and extended continuously from the data line DL. The drain electrode DE is spaced apart from the source electrode SE, with respect to the gate electrode GE. The semiconductor pattern 130 is disposed directly on the first insulation layer 120 corresponding to the gate electrode GE, such as overlapping a whole of the gate electrode GE in the first direction D1. The semiconductor pattern 130 includes a semiconductor layer 132 and an ohmic contact layer 134.

The second insulation layer 140 covers the resultant surface of on the first base substrate 101 on which the source electrode SE and the drain electrode DE are disposed. In an exemplary embodiment, the second insulation layer 140 may include the silicon nitride (“SiNx”) or the silicon oxide (“SiOx”) substantially the same as the first insulation layer 120.

The pixel electrode 150 is disposed on the first base substrate 101 on which the second insulation layer 140 is disposed. The pixel electrode 150 may include a transparent conductive material. In one exemplary embodiment, the pixel electrode 150 may include indium tin oxide (“ITO”) or indium zinc oxide (“IZO”). The pixel electrode 150 makes contact with the drain electrode DE of the switching element TFT through a contact hole CNT extended completely through the second insulation layer 140, so that the pixel electrode 150 is electrically and physically connected to the switching element TFT.

In an exemplary embodiment, the pixel electrode 150 may include an opening pattern to divide the unit pixel area into a plurality of domains. The pixel electrode 150 overlaps with portions of the first and second storage parts 112 and 114 to form the storage capacitor CST. A data voltage applied to the pixel electrode 150 for driving the switching element TFT is maintained during a frame by the storage capacitor CST.

Referring again to FIG. 3, the opposite substrate 200 may include a second base substrate 210, a light blocking pattern 220 and the common electrode 230.

The second base substrate 210 may include a transparent insulating material substantially the same as the first base substrate 101.

The light blocking pattern 220 is disposed directly on the second base substrate 210. The light blocking pattern 220 blocks light from an outside of the display device. In one exemplary embodiment, the light blocking pattern 220 may be disposed corresponding to an area in which the gate line GL, the data line DL and the switching element TFT are disposed overlapping each other, respectively.

The common electrode 230 covers the resultant surface of the second base substrate 210 on which the light blocking pattern 220 is disposed. The common electrode 230 may include a transparent conductive material. In one exemplary embodiment, the common electrode 230 may include ITO or IZO substantially the same as the pixel electrode 150.

Referring again to FIG. 1, the timing control part 500 receives a control signal CONT and image data DATA from an external apparatus, such as a graphic controller (not shown). The control signal CONT may include a main clock signal MCLK, a vertical synchronizing signal VSYNC, a horizontal synchronizing signal HSYNC, a data enable signal DE and so on.

Using the control signal CONT, the timing control part 500 generates a first control signal CONT1 to control a driving timing of the data driving part 600, a second control signal CONT2 to control a driving timing of the gate driving part 700 and a third control signal CONT3 to control the voltage generator 800. The first control signal CONT1 may include a horizontal starting signal STH, a load signal TP and a data clock signal DCLK. The second control signal CONT2 may include a vertical starting signal STV, a gate clock signal GCLK and an output enable signal OE and so on. The third control signal CONT3 may include the main clock signal MCLK.

The data driving part 600 receives the first control signal CONT1 and the image data DATA from the timing control part 500. The data driving part 600 converts the image data DATA into a data voltage having an analog type, based on the first control signal CONT1. The data driving part 600 outputs the data voltage to the data line DL.

The gate driving part 700 receives the second control signal CONT2 from the timing control part 500 and a gate driving voltage from the voltage generator 800. The gate driving part 700 generates gate driving signals to drive the gate line GL, based on the second control signal CONT2 from the timing control part 500 and the gate driving voltage from the voltage generator 800. The gate driving part 700 sequentially outputs the gate driving signals to the gate lines GL.

The voltage generator 800 receives the third control signal CONT3 from the timing control part 500. The voltage generator 800 generates driving voltages to drive the display panel 400 based on the third control signal CONT3.

The voltage generator 800 generates a gate driving voltage based on the third control signal CONT3 from the timing control part 500. The voltage generator 800 applies the gate driving voltage to the gate driving part 700. The gate driving voltage may include a gate-on voltage Von to generate a gate-on signal, and a gate-off voltage Voff to generate a gate-off signal.

The voltage generator 800 generates first and second common voltages Vcom1 and Vcom2 based on the third control signal CONT3 from the timing control part 500. The voltage generator 800 applies the first and second common voltages Vcom1 and Vcom2 to the display panel 400. The voltage generator 800 receives a feedback common voltage Vcomf fed back from the display panel 400. The voltage generator 800 outputs the first and second common voltages Vcom1 and Vcom2 applied to the display panel 400 by comparing a reference voltage VREF to the feedback common voltage Vcomf. The first common voltage Vcom1 is applied to the storage line 110 disposed on the display substrate 100 and electrically connected to the second terminal of the storage capacitor CST. The second common voltage Vcom2 is applied to the common electrode 230 disposed on the opposite substrate 200 and electrically connected to the second terminal of the liquid crystal capacitor CLC.

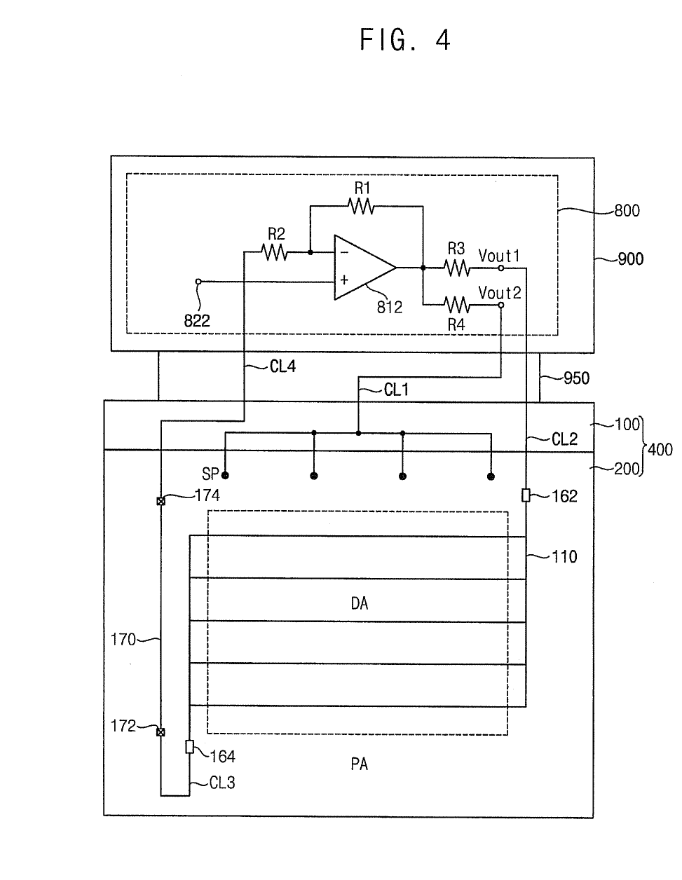

FIG. 4 is a circuit diagram of the display apparatus of FIG. 1.

Referring to the FIG. 4, a voltage generator 800 may be mounted on a printed circuit board (“PCB”) 900. The PCB 900 may be electrically connected to a display panel 400 through a flexible printed circuit board (“FPCB”) 950.

The voltage generator 800 may include an operation amplifier 812, a first resistor R1, a second resistor R2, a third resistor R3 and a fourth resistor R4.

A first input terminal (+) of the operation amplifier 812 is electrically connected to a reference voltage receiving terminal 822 so that the first input terminal (+) receives a reference voltage VREF.

A second input terminal (−) of the operation amplifier 812 receives a feedback common voltage Vcomf fed back from the display panel 400 through a dummy line 170 disposed on the display panel 400, and through the second resistor R2.

The operation amplifier 812 compares the reference voltage VREF to the feedback common voltage Vcomf and controls the feedback common voltage Vcomf so that the feedback common voltage Vcomf approaches the reference voltage VREF. In one exemplary embodiment, the operation amplifier 812 may be a differential amplifier which outputs first and second common voltages Vcom1 and Vcom2 by compensating for a difference between the reference voltage VREF and the feedback common voltage Vcomf.

The gain of the operation amplifier 812 is controlled by the line resistance of the dummy line 170, the first resistor R1 and the second resistor R2. The line resistance of the dummy line 170 is determined by a width of the line. In one exemplary embodiment, the line resistance of the dummy line 170 may decrease when the width of the line is increased, and the line resistance of the dummy line 170 may increase when the width of the line decreases.

A first output terminal Vout1 of the operation amplifier 812 is electrically connected to a storage line 110 disposed on a display substrate 100, so that the operation amplifier 812 applies the first common voltage Vcom1 to the storage line 110. A second output terminal Vout2 of the operation amplifier 812 is electrically connected to a plurality of short points SP, so that the operation amplifier 812 applies the second common voltage Vcom2 to the short points SP.

The first resistor R1 is electrically connected between the second input terminal (−) of the operation amplifier 812 and an output node N1 of the operation amplifier 812 as a feedback connection.

The second resistor R2 is electrically connected to the second input terminal (−) of the operation amplifier 812 and the dummy line 170 in series. In an exemplary embodiment, the second resistor R2 may be omitted.

The third resistor R3 is electrically connected between the first output terminal Vout1 of the operation amplifier 812 and the output node N1. The fourth resistor R4 is electrically connected between the second output terminal Vout2 of the operation amplifier 812 and the output node N1.

The display panel 400 includes the display substrate 100, an opposite substrate 200 and a liquid crystal layer 300 interposed between the display substrate 100 and the opposite substrate 200. The display substrate 100 includes a display area DA in which an image is displayed and a peripheral area PA which surrounds the display area DA. A plurality of storage lines 110 is disposed in the display area DA.

The short points SP, a signal input pad 162, a signal output pad 164, the dummy line 170, a first connection line CL1, a second connection line CL2, a third connection line CL3 and a fourth connection line CL4 may each be disposed in the peripheral area PA, as shown in FIG. 4. Each of the short points SP, the signal input pad 162, the signal output pad 164, the dummy line 170 and the third connection line CL3 may each be disposed in only in the peripheral area PA of the display substrate 100.

The short points SP are electrically connected to the second output terminal Vout2 of the operation amplifier 812 through the first connection line CL1 so that the short points SP receive the second common voltage Vcom2. The display substrate 100 electrically connect to the common electrode 230 of the opposite substrate 200 through the short points SP, so that the second common voltage Vcom2 is applied to the common electrode 230 through the short points SP.

The signal input pad 162 is electrically connected to the first output terminal Vout1 of the operation amplifier 812 through the second connection line CL2, so that the signal input pad 162 receives the first common voltage Vcom1. The signal input pad 162 is electrically connected to a first terminal (e.g., a first distal end) of the storage line 110 so that the signal input pad 162 applies the first common voltage Vcom1 received from the operation amplifier 812 to the storage line 110.

The signal output pad 164 is electrically connected to the dummy line 170 through the third connection line CL3. The signal output pad 164 is electrically connected to a second terminal (e.g., a second distal end) of the storage line 110, so that the signal output pad 164 applies the feedback common voltage Vcomf received from the storage line 110 to the dummy line 170. The second terminal of the storage line 110 is disposed at an opposing end of the storage line 110 with respect to the first terminal.

The dummy line 170 is disposed in the peripheral area PA of the display substrate 100. An entire of the dummy line 170 may be disposed only in the peripheral area PA, such as a non-display area, of the display substrate 100, as shown in FIG. 4. The dummy line 170 is electrically insulated in the peripheral area PA. In the illustrated embodiment, the dummy line 170 includes substantially the same material as a data line DL disposed in the display area DA of the display substrate 100. The dummy line 170 may be formed on the same layer as a layer on which the data line is formed. In one exemplary embodiment, the dummy line 170 is formed via substantially the same manufacturing process as the data line DL. Therefore, when the width of the data line DL is changed due to process variations, the width of the dummy line 170 is changed as well. The dummy line 170 is connected to the second resistor R2 through the fourth connection line CL4 in series. In an exemplary embodiment, the second resistor R2 may be omitted. When the second resistor R2 is omitted, the dummy line 170 may be directly connected to the second input terminal (−).

A first terminal of the first connection line CL1 is electrically connected to the second output terminal Vout2 of the operation amplifier 812. A second terminal of the first connection line CL1 is electrically connected to the short points SP.

A first terminal of the second connection line CL2 is electrically connected to the first output terminal Vout1 of the operation amplifier 812. A second terminal of the second connection line CL2 is electrically connected to the signal input pad 162.

A first terminal of the third connection line CL3 is electrically connected to the signal output pad 164. A second terminal of the third connection line CL3 is electrically connected to a first connecting portion 172 connected to a first terminal of the dummy line 170.

A first terminal of the fourth connection line CL4 is electrically connected to the second resistor R2. A second terminal of the fourth connection line CL4 is electrically connected to a second connecting portion 174. In an exemplary embodiment, the second resistor R2 may be omitted. When the second resistor R2 is omitted, the first terminal of the fourth connection line CL4 may be connected to the second input terminal (−) directly.

According to the illustrated exemplary embodiment, the gain of the operation amplifier 812 is automatically controlled according to the line resistance of the dummy line 170 which is formed in substantially the same manufacturing process as the data line DL. Therefore, even though the distortion of the first and the second common voltage Vcom1 and Vcom2 increases as the width of the data line DL is increased due to process variations, the distortion may be decreased.

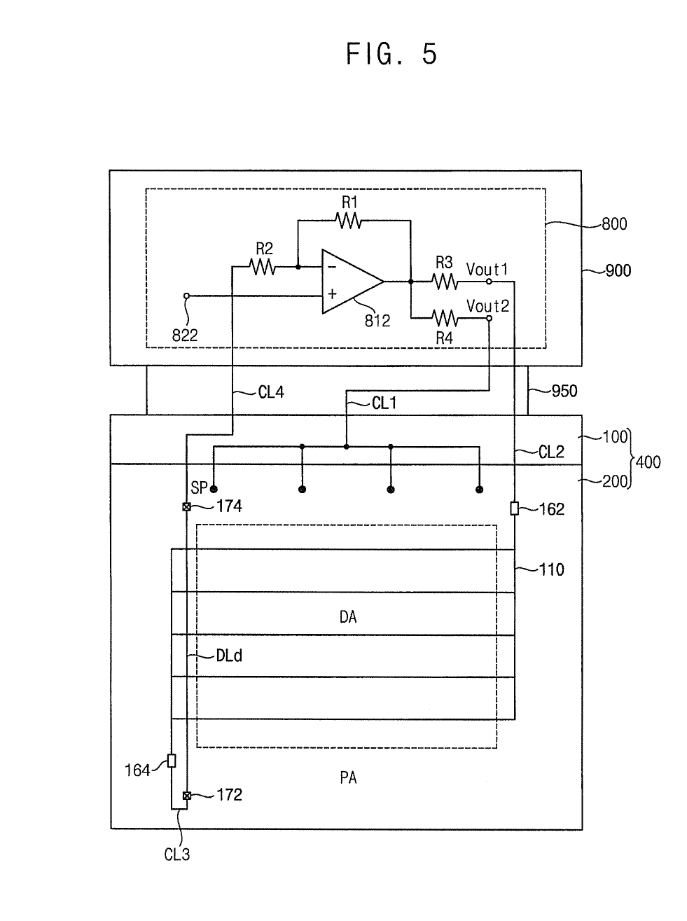

FIG. 5 is a circuit diagram of a display apparatus according to another exemplary embodiment of the present invention.

The display apparatus according to the illustrated exemplary embodiment is substantially the same as the display apparatus according to the previous exemplary embodiment in FIGS. 1 to 4, except for a dummy data line DLd connected to a second input terminal (−) of an operation amplifier 812. Thus, the same reference numerals will be used to refer to the same or like parts as those described in the display apparatus in FIGS. 1, 2, 3 and 4 and any further repetitive explanation concerning the above elements will be omitted.

Referring to FIGS. 1 and 5, the display apparatus according to the illustrated exemplary embodiment may include a display panel 400, a timing control part 500, a data driving part 600, a gate driving part 700, a voltage generator 800, a PCB 900 and a flexible printed circuit board (“FPCB”) 950.

The voltage generator 800 may be mounted on the PCB 900. The PCB 900 may be electrically connected to the display panel 400 through an FPCB 950.

The voltage generator 800 may include an operation amplifier 812, a first resistor R1, a second resistor R2, a third resistor R3 and a fourth resistor R4.

A first input terminal (+) of the operation amplifier 812 is electrically connected to a reference voltage receiving terminal 822 so that the first input terminal (+) receives a reference voltage VREF.

A second input terminal (−) of the operation amplifier 812 receives a feedback common voltage Vcomf fed back from the display panel 400 through a dummy data line DLd which is disposed on the display panel 400, and the second resistor R2. The operation amplifier 812 compares the reference voltage VREF to the feedback common voltage Vcomf and controls the feedback common voltage Vcomf so that the feedback common voltage Vcomf approaches the reference voltage VREF.

A first output terminal Vout1 of the operation amplifier 812 is electrically connected to a storage line 110 disposed on a display substrate 100 so that the operation amplifier 812 applies the first common voltage Vcom1 to the storage line 110. A second output terminal Vout2 of the operation amplifier 812 is electrically connected to a plurality of short points SP so that the operation amplifier 812 applies the second common voltage Vcom2 to the short points SP.

The first resistor R1 is electrically connected between the second input terminal (−) of the operation amplifier 812 and an output node N1 of the operation amplifier 812 as a feedback connection.

The second resistor R2 is electrically connected to the second input terminal (−) of the operation amplifier 812 and the dummy data line DLd in series. In an exemplary embodiment, the second resistor R2 may be omitted.

The third resistor R3 is electrically connected between the first output terminal Vout1 of the operation amplifier 812 and the output node N1 of the operation amplifier 812. The fourth resistor R4 is electrically connected between the second output terminal Vout2 of the operation amplifier 812 and an output node N1 of the operation amplifier 812.

The display panel 400 includes the display substrate 100, an opposite substrate 200 and a liquid crystal layer 300 interposed between the display substrate 100 and the opposite substrate 200. The display substrate 100 includes a display area DA in which images are displayed, and a peripheral area PA which surrounds the display area DA. A plurality of storage lines 110 is disposed in the display area DA.

The dummy data line DLd is electrically connected to a dummy pixel (not shown) disposed in the peripheral area PA.

The short points SP, a signal input pad 162, a signal output pad 164, a first connection line CL1, a second connection line CL2, a third connection line CL3 and a fourth connection line CL4 may be disposed in the peripheral area PA.

The short points SP are electrically connected to the second output terminal Vout2 of the operation amplifier 812 through the first connection line CL1 so that the short points SP receives the second common voltage Vcom2. The short points SP connect the display substrate 100 to a common electrode 230 of the opposite substrate 200 so that the short points SP apply the second common voltage Vcom2 to the common electrode 230.

The signal input pad 162 is electrically connected to the first output terminal Vout1 of the operation amplifier 812 through the second connection line CL2 so that the signal input pad 162 receives the first common voltage Vcom1. The signal input pad 162 is electrically connected to a first terminal of the storage line 110 so that the signal input pad 162 applies the first common voltage Vcom1 received from the operation amplifier 812 to the storage line 110.

The signal output pad 164 is electrically connected to the dummy data line DLd through the third connection line CL3. The signal output pad 164 is electrically connected to a second terminal of the storage line 110 so that the signal output pad 164 applies the feedback common voltage Vcomf received from the storage line 110 to the dummy data line DLd. The dummy data line DLd overlaps portions of the storage line 110, as shown in FIG. 5.

A first terminal of the first connection line CL1 is electrically connected to the second output terminal Vout2 of the operation amplifier 812. A second terminal of the first connection line CL1 is electrically connected to the short points SP.

A first terminal of the second connection line CL2 is electrically connected to the first output terminal Vout1 of the operation amplifier 812. A second terminal of the second connection line CL2 is electrically connected to the signal input pad 162.

A first terminal of the third connection line CL3 is electrically connected to the signal output pad 164. A second terminal of the third connection line CL3 is electrically connected to a first connecting portion 172 connected to a first terminal of the dummy data line DLd.

A first terminal of the fourth connection line CL4 is electrically connected to the second resistor R2. A second terminal of the fourth connection line CL4 is electrically connected to a second connecting portion 174. In an exemplary embodiment, the second resistor R2 may be omitted. When the second resistor R2 is omitted, the first terminal of the fourth connection line CL4 may be directly connected to the second input terminal (−).

According to the illustrated exemplary embodiment, the gain of the operation amplifier 812 is automatically controlled according to the line resistance of the dummy data line DLd which is formed in substantially the same manufacturing conditions as the data line DL. Therefore, even though distortion of the first and the second common voltage Vcom1 and Vcom2 increases as the width of the data line DL is increased due to process variations, the distortion may be decreased.

According to the present invention, even though distortion of a common voltage increases as the width of a data line is increased due to process variations, the distortion may be decreased. Therefore, crosstalk due to the distortion of a data voltage may be reduced or effectively prevented so that the display quality of a display apparatus may be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a voltage generator comprising:
an operation amplifier comprising a first input terminal electrically connected to a reference voltage receiving terminal, a second input terminal receiving a feedback common voltage, and an output terminal outputting a common voltage generated based on comparison of a reference voltage received at the reference voltage receiving terminal with the feedback common voltage; and
a first resistor electrically connected between the second input terminal and the output terminal;
a display panel comprising a dummy line electrically connected in series between a first connection line and a second connection line, the dummy line providing the feedback common voltage to the second input terminal of the operation amplifier through the first connection line; and
a panel driving part driving the display panel.

2. The display apparatus of claim 1, wherein the display panel further comprises:
a display substrate comprising a display area in which gate and data lines are disposed, and a peripheral area surrounding the display area, the gate and data lines respectively crossing each other;
an opposite substrate comprising a common electrode; and
a liquid crystal layer interposed between the display substrate and the opposite substrate.

3. The display apparatus of claim 2, wherein the dummy line is disposed in the peripheral area, and includes substantially the same material as the data lines.

4. The display apparatus of claim 1, wherein the voltage generator further comprises a second resistor electrically connected to the second input terminal of the operation amplifier, and electrically connected to the dummy line in series.

5. The display apparatus of claim 3, wherein the voltage generator further comprises a second resistor electrically connected to the second input terminal of the operation amplifier, and electrically connected to the dummy line in series.

6. The display apparatus of claim 2, wherein the display substrate further comprises a dummy pixel, and the dummy line is electrically connected to the dummy pixel.

7. The display apparatus of claim 6, wherein the voltage generator further comprises a second resistor electrically connected to the second input terminal of the operation amplifier and electrically connected to the dummy line in series.

8. The display apparatus of claim 2, wherein the panel driving part comprises:
a data driving part outputting a data signal to the data lines; and
a gate driving part outputting a gate signal to the gate lines.

9. The display apparatus of claim 8, wherein the voltage generator further comprises:
a third resistor electrically connected between a first output terminal of the operation amplifier and the output terminal; and
a fourth resistor electrically connected between a second output terminal of the operation amplifier and the output terminal.

10. The display apparatus of claim 9, wherein the display substrate further comprises:
a plurality of short points disposed in the peripheral area of the display substrate, and applying a second common voltage outputted from the second output terminal of the operation amplifier to the common electrode; and
a third connection line electrically connecting the second output terminal of the operation amplifier to the short points.

11. The display apparatus of claim 10, wherein the display substrate further comprises a storage line disposed in the display area.

12. The display apparatus of claim 11, wherein the storage line comprises:
a first storage line extended substantially in parallel with the gate lines; and
a second storage line extended from the first storage line, in parallel with the data lines and overlapping with a data line.

13. The display apparatus of claim 11, wherein the display substrate further comprises:
a signal input pad disposed in the peripheral area, electrically connected to a first terminal of the storage line and applying a first common voltage outputted from the first output terminal of the operation amplifier to the storage line; and
a signal output pad disposed in the peripheral area, electrically connected to a second terminal of the storage line opposing the first terminal, and applying the feedback common voltage fed back from the storage line to the dummy line through the second connection line.

14. The display apparatus of claim 13, wherein the display substrate further comprises a fourth connection line electrically connecting the first output terminal of the operation amplifier to the signal input pad.

15. A method of forming a display apparatus, the method comprising:
providing a voltage generator comprising:
an operation amplifier comprising a first input terminal electrically connected to a reference voltage receiving terminal, a second input terminal receiving a feedback common voltage, and an output terminal outputting a common voltage generated based on comparison of a reference voltage received at the reference voltage receiving terminal with the feedback common voltage; and
a first resistor electrically connected between the second input terminal and the output terminal;
providing a display panel comprising:
a dummy line formed electrically connected in series between a first connection line and a second connection line, the dummy line providing the feedback common voltage to the second input terminal of the operation amplifier through the first connection line; and
a display substrate comprising a display area in which gate and data lines are formed, and a peripheral area surrounding the display area, the gate and data lines respectively crossing each other; and
providing a panel driving part driving the display panel,
wherein the dummy line and the data lines are formed in substantially the same manufacturing process such that when a width of the data lines is changed due to process variations, a width of the dummy line is also changed, and the dummy line includes substantially the same material as the data lines.

16. The display apparatus of claim 15, wherein the dummy line is disposed in the peripheral area, and includes substantially the same material as the data lines.

17. The display apparatus of claim 15, wherein the display substrate further comprises a dummy pixel, and the dummy line is electrically connected to the dummy pixel.
